(19) United States
(12) Patent Application Publication
(10) Pub. No.: US 2013/0101288 A1
(43) Pub. Date: Apr. 25, 2013

(54) Optical Switch for Networks Using Wavelength Division Multiplexing

(71) Applicants: David Jeffrey Graham, Sewickley, PA (US); David Markham Drury, Pittsburgh, PA (US); Eric John Helmsen, Wexford, PA (US)

(72) Inventors: David Jeffrey Graham, Sewickley, PA (US); David Markham Drury, Pittsburgh, PA (US); Eric John Helmsen, Wexford, PA (US)

(73) Assignee: ACCIPITER SYSTEMS, INC., Pittsburgh, PA (US)

(21) Appl. No.: 13/276,805

(22) Filed: Oct. 19, 2011

(51) Int. Cl. H04J 14/02

(52) U.S. Cl. 398/49; 398/45; 398/48

(57) ABSTRACT

A switch for switching optical signals. The switch includes a plurality of inputs, wherein each of the plurality of inputs receives one of a plurality of input signals, and at least one coupling element operably connected to two or more of the plurality of inputs and configured to combine at least two of the input signals into a combined output signal. The switch further includes a splitting element operably connected to the at least one coupling element and configured to demultiplex the combined output signal to produce a plurality of demultiplexed output signals. A control plane processor is operably connected to at least one of the plurality of inputs and is configured to determine a schedule for one or more devices operably connected to the plurality of inputs to transmit data bursts.

### BACKGROUND

The disclosed embodiments generally relate to the fields of optical networks, data switching and data routing. More specifically, the disclosed embodiments generally relate to an optical switch for switching incoming data to a specific output.

Telecommunication systems and data networking systems have rapidly grown in speed and capacity. Accompanying the growth of these systems, however, has been the increasing cost of maintaining these systems. A typical network, such as a local area network (LAN), requires a large and costly infrastructure. For example, groups of servers must be included in the LAN to handle requests from users of the LAN, direct these requests accordingly, maintain various shared files and other resources, and provide a gateway to other networks, such as the Internet. In addition to the servers, each LAN must have a series of routers and switches to direct traffic generated by the users of the LAN. The servers, switches and routers, as well as the users' computers must all be connected via cabling or a wireless connection. These various devices and connections all require significant power, cooling, space and financial resources to ensure proper functionality.

Fiber optic cables have been used to replace standard coaxial or copper-based connections in communication networks. Fiber optic cables typically use glass or plastic to propagate light through a network. Specialized transmitters and receivers utilize the propagating light to send data through the fiber optic cables from one device to another. Fiber optic cables are especially advantageous for long-distance communications, because light propagates through the fibers with little attenuation as compared to electrical cables. This allows long distances to be spanned with few repeaters, thereby reducing the cost of a communication network.

In fiber-optic communications, wavelength-division multiplexing (WDM) is a technology that multiplexes multiple optical carrier signals on a single optical fiber by using different wavelengths of light to carry different signals. In this way, WDM allows for a multiplication in capacity.

A WDM system typically uses a multiplexer to join multiple optical carrier signals together at a transmitter, and a demultiplexer at the receiver to split the multiplexed signal into its original optical carrier signals. WDM systems are generally broken into three different wavelength patterns: conventional, coarse and dense.

Conventional WDM systems employ channel spacing on the order of 400 GHz and typically use wavelengths in the “C” band between 1530 and 1565 nm (see Table 1 below). The channel spacing, however, restricted the number of multiplexed wavelengths to between 8 and 16.

Dense Wave Division Multiplexing (DWDM) also refers to optical signals multiplexed within the 1530-1565 nm “C” band, but with much closer channel spacing and, therefore, the ability to multiplex additional optical channels. 100 GHz spacing, resulting in 40 channels, and 50 GHz channel spacing, resulting in 80 channels in the “C” band, are both common for DWDM systems, with some DWDM systems supporting alternative channel spacing such as 25 GHz.

Alternatively, coarse WDM (CWDM) systems use the entire frequency band from 1260 to 1675 nm with 20 nm channel spacing, thereby resulting in lower cost and less sophisticated transceiver designs.

Table 1 provides a list of band designations specified by the International Telecommunication Union for the main transmission regions of fiber optic cables and the wavelength ranges covered by each transmission region. Typically, DWDM falls into the 1530-1565 nm range, however, advances in materials and construction methods for optical fibers has increased this range to nearly the entire range of main transmission regions, i.e., 1260-1675 nm.

TABLE 1
ITU Standard Optical Band Definitions

| Band | Descriptor | Wavelength Range |
|---|---|---|
| O band | Original | 1260-1360 nm |
| E band | Extended | 1360-1460 nm |
| S band | Short Wavelength | 1460-1530 nm |
| C band | Conventional | 1530-1565 nm |
| L band | Long Wavelength | 1565-1625 nm |
| U band | Ultralong Wavelength | 1625-1675 nm |

As both communication systems grow and fiber optic systems become more integrated into standard communications, the speed, and resultant cost, of individual network components is also growing. Huge investments must be made by telecommunication companies to keep up with consumer demand as well as technological developments. As a result, telecommunication companies as well as businesses running their own communication networks would benefit greatly from network components with reduced size, weight, cost and power requirements. However, development has progressed slowly in this area. Instead, network components are simply made bigger and heavier, and consume more power in the pursuit of supplying higher bandwidth.

In atypical environments, such as airborne or shipborne networks, size, weight and power become even more important for network design. However, the lack of progress in reducing the size, weight and power of network components described above has restricted the availability of high-bandwidth networks in such environments.

For example, space is at a premium on most airplanes and smaller ships. As such, network components of the size used in most business environments could exceed the available storage space in such environments. Data networks capable of providing on-demand video and audio programming to airplane passengers have developed slowly at least because of the size of conventional networking equipment. Similarly, military aircraft often require high-speed communication between subsystems or are used as a flying communication hub. However, conventional networking equipment is limited in its ability to perform this task because of the limited footprint that can be provided to all functions in an aircraft.

In addition, the weight of a network component has a direct effect on fuel consumption in airborne or shipborne environments because the added weight increases the drag on the airplane or ship. Similarly, the amount of power consumed by network components directly affects fuel consumption since power in airborne and shipborne environments is generated within the environment itself. For ships that are at sea for long periods of time, the power consumed by conventional networking equipment inhibits the ability to use such equipment because of the drain on limited energy reserves.

One approach at reducing the number of network components has been to implement a ring topology. For example, U.S. patent application Ser. No. 12/477,576 filed Jun. 3, 2009 and entitled “Optical Network Systems and Methods for Operating Same,” the content of which is hereby incorporated herein in its entirety, teaches such a ring topology. However, this specific implementation uses each node in the network as a link in the ring, and as such, if any node is removed or otherwise becomes unusable, the network may fail.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a switch for switching optical signals. The switch includes a plurality of inputs, wherein each of the plurality of inputs receives one of a plurality of input signals; at least one coupling element operably connected to two or more of the plurality of inputs and configured to combine at least two of the input signals into a combined output signal; a splitting element operably connected to the at least one coupling element and configured to demultiplex the combined output signal to produce a plurality of demultiplexed output signals; and a control plane processor operably connected to at least one of the plurality of inputs and configured to determine a schedule for one or more devices operably connected to the plurality of inputs to transmit data bursts.

In another general respect, the embodiments disclose a switch for switching optical signals. The switch includes a plurality of ports, each port including an input and an output; at least one coupling element operably connected to a plurality of the inputs and configured to combine a plurality of input signals into a combined output signal; a splitting element operably connected to the at least one coupling element and configured to demultiplex the combined output signal to produce a plurality of demultiplexed output signals and direct one of the demultiplexed output signals to at least one output; and a control plane processor operably connected to at least one control input and configured to determine a schedule for one or more devices operably connected to the plurality of inputs to transmit data bursts intended for one or more devices operably connected to the plurality of outputs.

In yet another general respect, the embodiments disclose a switch for switching optical signals. The switch includes a plurality of inputs, wherein each of the plurality of inputs receives one of a plurality of input signals, each of the plurality of input signals having a wavelength; at least one router operably connected to the plurality of inputs and configured to route each of the input signals to one of a plurality of outputs based upon the wavelength of the input signal; and a control plane processor operably connected to the at least one router and configured to determine a schedule for one or more devices operably connected to the plurality of inputs to transmit data bursts intended for one or more devices operably connected to the plurality of outputs.

### BRIEF DESCRIPTION OF THE DRAWINGS

FIG. 1 illustrates an exemplary optical network according to an embodiment.

FIG. 2 illustrates an exemplary switch for use in the network of FIG. 1 according to an embodiment.

FIG. 3 illustrates an alternative switch according to an embodiment.

FIG. 4 illustrates an alternative switch according to an embodiment.

FIG. 5 illustrates a data network incorporating multiple switches according to an embodiment.

### DETAILED DESCRIPTION

The following terms shall have, for the purposes of this application, the respective meanings set forth below.

A “burst” refers to a sequence of bits of information transmitted by a node, a burst including, but not limited to, raw data, framed data, or data arranged into packets prior to transmission. A burst may be transmitted from one node to one or more destination nodes over a network.

A “node” refers to a system (e.g., processor-based, field programmable gate array (FPGA) based or memory-based) configured to transmit and/or receive information from one or more other nodes via a network. For example, a node may transmit to one or more destination nodes by varying the frequency of its transmissions to match a frequency at which its burst is switched to a specific destination node.

A “switch” refers to a network component that provides bridging and/or switching functionality between a plurality of nodes. A switch may have a plurality of inputs and a corresponding number of outputs. Each node may be operably connected to a switch via both an input fiber and an output fiber.

An “Optical Burst” (OB) network refers to a network constructed from a plurality of nodes and one or more switches. An OB network uses optical transmissions to send data bursts between a source node and one or more destination nodes.

An “end device” is a network component that exists at the edge of a network. End devices may be components that end users interact with to access the network, including, but not limited to, computers and workstations. An end device may also be a component that an end user does not directly interact with, including, but not limited to, email servers and web servers. An end device may include one or more end device interfaces for operably connecting to the network.

Terabit Optical Ethernet (“TOE”) is a network architecture and transmission protocol that may be used to implement local, wide and/or metropolitan area networks. An exemplary TOE may be found in U.S. Pat. No. 7,751,709 filed Jan. 18, 2006 and entitled “Method and System for Interconnecting End Systems over an Optical Network,” the contents of which are hereby incorporated by reference. TOE may transmit 100s of terabits of information per second over single mode fibers that are common today. TOE is a highly scalable architecture allowing controlled access to a common shared fiber media.

In the present disclosure, the underlying principles of TOE have been used to provide an alternative architecture providing a better match to specific requirements of large concentrated assemblies of processors and storage devices in an OB network.

An OB network resolves these problems by removing layers of conventional infrastructure equipment. Moreover, power, cooling and packaging costs are dramatically reduced as a result of the reduction in physical infrastructure. In addition, an OB network is easily scalable and can benefit from increases in optical technologies for improved bandwidth over time. An OB network is inherently transparent to the nature of the bursts carried over it, and may be designed to carry Ethernet traffic by providing Ethernet interfaces to connected computer systems, PCI Express traffic through PCI Express interfaces, Fiber Channel traffic through Fiber Channel interfaces, and so forth. OB, and methods of using OB networks to reduce network costs by interfacing various computer systems via an optical switch are discussed below with reference to the figures.

An exemplary OB network as discussed herein may include at least three basic elements: a plurality of nodes, at least one switching device and a plurality of optical fibers. Each node may include one or more transceivers used to access the optical fibers. An optical transceiver may be an integrated circuit configured to transmit and receive a signal via an optical fiber. An optical fiber is typically a glass or plastic tube configured to carry an optical signal. In the exemplary OB network as discussed herein, an optical fiber (single-mode or multimode) may be used to link each node to the switching device, thereby establishing a network, such as a LAN.

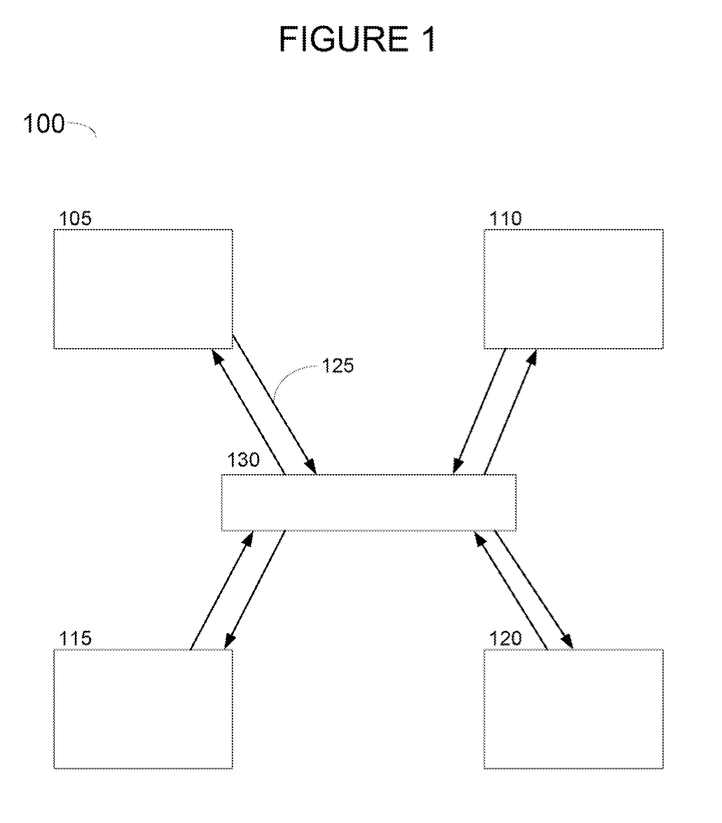

FIG. 1 illustrates a system level diagram of an exemplary OB network 100. The OB network 100 may include four nodes 105, 110, 115 and 120 interconnected by a series of optical fibers 125 to a switch 130. The optical fibers may include single mode and multimode optical fibers. Each node may be connected to both an input terminal and an output terminal of the switch 130. Each node may also be associated with a specific wavelength such that a burst from a node is switched to the wavelength of a specific destination node for transmission. Each node may also be associated with a set of specific wavelengths such that a node will switch a burst from that node to one of the other nodes. The wavelength for each node may be used by each of the other nodes and the switch in concert such that the bursts are correctly switched to the appropriate destination. For example, in the OB network 100, nodes 110, 115 and 120 may use wavelength A to access node 105, nodes 105, 115 and 120 may use wavelength B to access node 110, nodes 105, 110 and 120 may use wavelength C to access node 115, and nodes 105, 110 and 115 may use wavelength D to access node 120. In one embodiment, OB nodes may be associated with wavelengths in the infrared spectrum. However, other wavelengths may also be used as will be apparent based on the teachings of the present disclosure.

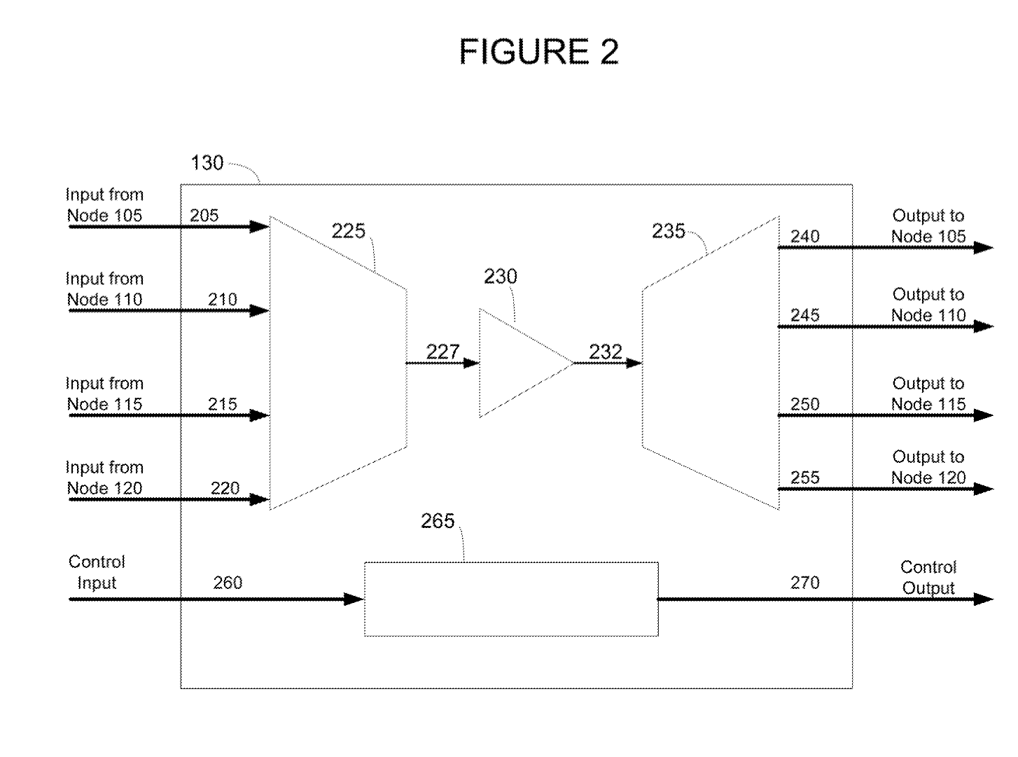

In order for one node to transmit data to another node, the node must label the data with the wavelength associated with the required destination. For example, node 105 may send a packet intended for node 120 at wavelength D. The node 105 may transmit the packet to switch 130. The switch 130 may receive the packet and output the packet to node 120 accordingly. The internal architecture of the switch 130 is discussed in greater detail below with respect to FIGS. 2-4. An example of a passive network switch is shown in U.S. patent application Ser. No. 13/035,045 filed Feb. 25, 2011 and titled “Optical Switch for Implementing Wave Division Multiplexing Networks,” the content of which is hereby incorporated by reference in its entirety.

In order to support transmissions at multiple wavelengths, each node may be able to change the wavelength at which it transmits on a burst-by-burst basis. Exemplary systems for transmitting using multiple wavelengths include electronically tunable lasers or systems using multiple lasers at each node.

FIG. 2 illustrates an exemplary architecture for the switch 130. The switch 130 may include a plurality of inputs 205, 210, 215 and 220, each of which is associated with one of nodes 105, 110, 115 and 120, respectively. Each of the inputs may be operably connected via an optic fiber to a first stage of the switch 130. The first stage may be arranged such that all incoming signals received via any of the inputs 205, 210, 215 and 220 are multiplexed via a joining function or joining element and are output via a single optic fiber. Exemplary joining elements may include optical combiners, optical couplers, and other similar devices configured to multiplex a plurality of optical input signals into a single optical output signal. As shown in FIG. 2, the exemplary switch 130 may include a combiner 225. The combiner 225 may be configured such that each of inputs 205, 210, 215 and 220 is combined or multiplexed into a single output fiber 227. In this example, the first stage output is a single fiber 227 with up to four WDM signals comprising each of the inputs 205, 210, 215 and 220.

The WDM output signal 227 may be directed via an optic fiber to an amplifier 230. The amplifier 230 may boost the output signal 227 and output a boosted WDM output signal 232 to a splitting function or splitting element. The splitting element may be arranged and configured such that the boosted WDM output signal 232 is demultiplexed into individual signal components. Examples of splitting elements may include an arrayed waveguide grating (AWG), an optical splitter, and other similar devices configured to demultiplex an optical signal, such as the boosted WDM output signal 232, into one or more output components. As shown in FIG. 2, the exemplary switch 130 may include an AWG 235. The AWG 235 may be configured such that it operates as an optical demultiplexer by receiving the boosted WDM output signal 232, demultiplexing the signal into its individual components, each having an associated wavelength, and directing each individual signal component to an appropriate output 240, 245, 250 or 255 based upon its associated wavelength.

In addition to the routing components, the switch 130 may also include control plane components. Each node may be further configured to transfer a control input signal 260 to a control plane processor 265. The control input signal 260 may include information related to bursts queued for transmission such as their destination and priority. The control plane processor 265 may be operably connected to the nodes via an out-of-band control channel. An out-of-band control channel may be carried on a separate and unique wavelength from any of the nodes such that data intended for the control plane processor is easily split from any intra-node traffic. Alternatively, the control channel may be on another optical fiber or another connection medium such as copper wire.

The control plane processor 265 may be configured to receive the control input signal 260, process the input signal, and output a control output signal 270. The control output signal 270 may indicate to which destination node a given node may transmit at the next time a burst is scheduled from that node.

For example, node 105 may have a series of bursts to send to node 120. The control plane processor 265 may receive an incoming control input signal 260 from the node 105, as well as from nodes 110, 115 and 120. The incoming control input signal 260 from each node may indicate the different destination nodes for which a particular node has bursts, as well as the priority of each burst. The control plane processor 265 may determine a schedule in which each of nodes 105, 110, 115 and 120 is allowed to transmit queued bursts to their destinations. The control plane processor 265 may pass a control output 270 indicating these scheduling decisions to each of the nodes 105, 110, 115 and 120. Thus, the control plane processor may be responsible for ensuring only one input is accessing a given output at a specific instance of time.

The node 105 may receive one or more control outputs 270 from the control plane processor 265. Based upon the schedule provided by the control output 270, the node 105 may transmit the series of bursts to the switch 130 at wavelength D, i.e., the wavelength associated with node 120 in accordance with the schedule as determined by the control plane processor 265. The combiner 225 receives the series of bursts from node 105 via input 205, and multiplexes the series of bursts along with any other incoming data from inputs 210, 215 and 220 into a single WDM output signal 227.

The amplifier 230 receives the WDM output signal 227 and passes a boosted WDM output signal 232 to the AWG 235. The AWG 235 receives the boosted WDM output signal 232 comprising the series of bursts intended for node 120. The AWG may demultiplex the boosted WDM output signal 232 into its individual components. Any signal components having wavelength A (i.e., intended for node 105) are transmitted to node 105 via output 240, any signal components having wavelength B (i.e., intended for node 110) are transmitted to node 110 via output 245, any signal components having wavelength C (i.e., intended for node 115) are transmitted to node 115 via output 250, and any components having wavelength D (i.e., intended for node 120) such as the series of bursts from node 105 are transmitted to node 120 via output 255.

In order to achieve such a demultiplexing, the AWG 235 may be configured or tuned to output via a set of specific wavelengths. For example, each output of the AWG 235 may be a particular number of nanometers apart. For example, if the AWG 235 is configured to operate on the C band (it should be noted other bands are possible and the C band is used for exemplary purposes only), each of the outputs may be assigned to wavelengths that are 5 nm apart. Furthering the example above, wavelength λ may be 1530 nm, wavelength B may be 1535 nm, wavelength C may be 1540 nm, wavelength D may be 1545 nm and wavelength E may be 1550 nm. The AWG 235 may be configured or tuned accordingly such that the output 240 corresponds to 1530 nm, the output 245 corresponds to 1535 nm, the output 250 corresponds to 1540 nm, and the output 255 corresponds to 1545 nm. The control plane processor 265 may be configured to identify any data transmitted at 1550 nm is intended for the control plane. Thus, each individual signal component of boosted WDM output signal 232 corresponding to those specific wavelengths is directed by AWG 235 to the appropriate output, and any individual signal components transmitted by one of nodes 105, 110, 115 and 120 intended for the control plane is received by the control plane processor 265. Alternative methods of assigning the outputs of the AWG, such as by differences in frequency, and alternative methods of transmitting information to the control plane processor may also be performed within the scope of this disclosure.

Each node operably connected to the switch 130 therefore has an associated port that includes an input connection and an output connection. The output connection is associated with the specific wavelength (or frequency) assigned to that node. In the exemplary embodiment illustrated in FIGS. 1 and 2, node 105 has a port including input 205 and output 240, node 110 has a port including input 210 and output 245, node 115 has a port including input 215 and output 250, and node 120 has a port including input 220 and output 255.

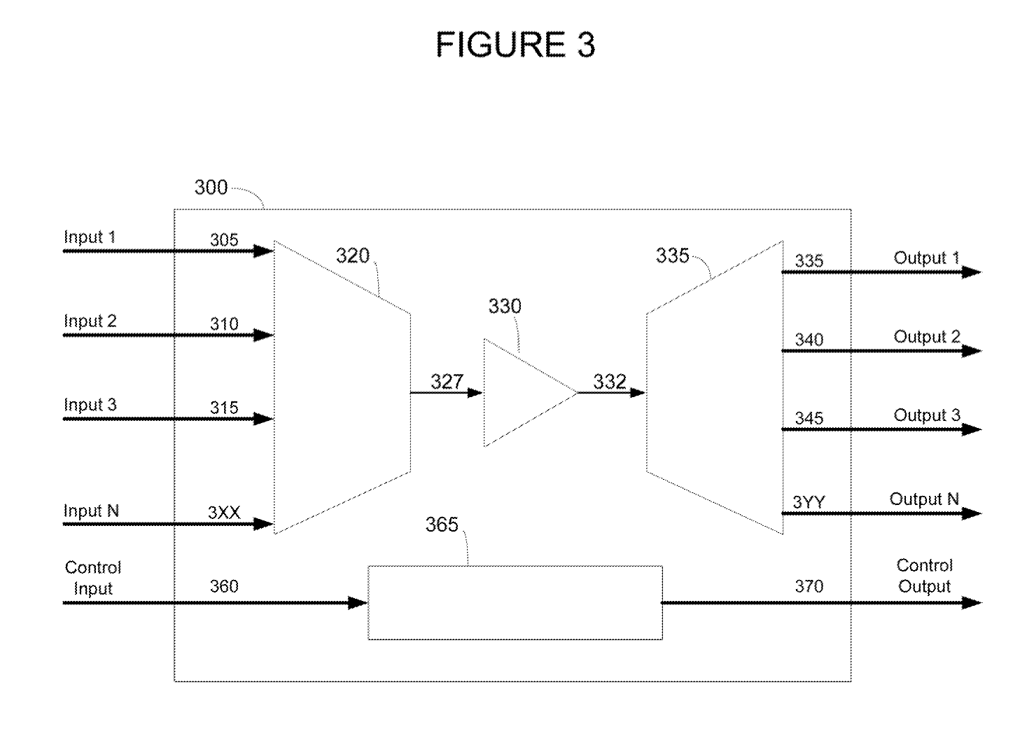

It should be noted the arrangement and architecture of switch 130 as shown in FIG. 2 is shown by way of example only. The switch may be scaled accordingly to handle a larger number of inputs and outputs. For example, as shown in FIG. 3, a switch 300 may include inputs from nodes 1, 2, 3, . . . , N received via inputs 305, 310, 315, . . . , 3XX. Each of the inputs may be combined in an N:1 combiner 320. A WDM output signal 327 may be passed to an amplifier 330. The amplifier 330 may boost the WDM output signal 327 and pass a boosted WDM output signal 332 to a 1:N AWG 335, where the output signal is split into N components and switched to nodes 1, 2, 3, . . . , N via outputs 335, 340, 345, . . . , 3YY. Similarly, a control input signal 360 may be received by a control plane processor 365. The control plane processor 365 may process the control input signal 360 and output a control output signal 370.

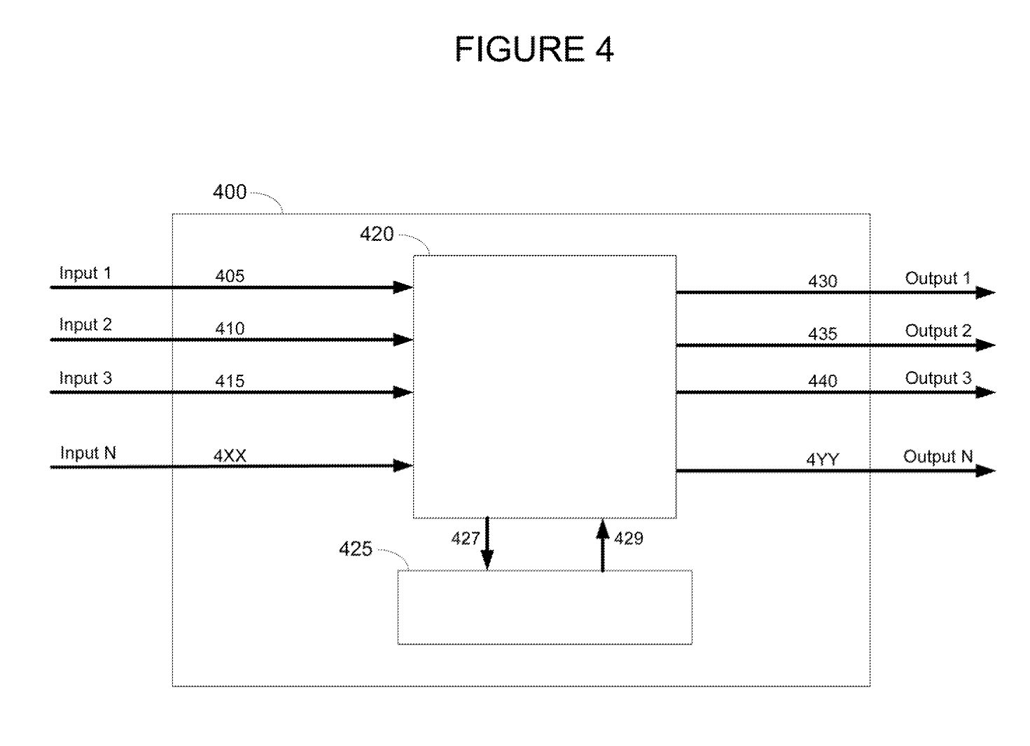

FIG. 4 illustrates an alternative switch 400 for routing incoming data bursts to an appropriate destination. The switch 400 may include inputs from nodes 1, 2, 3, . . . , N received via inputs 405, 410, 415, . . . , 4XX. Each of the inputs may be passed to a router 420. The router 420 may be configured to receive a plurality of optical signals and, based upon the wavelength of an individual optical signal, output each of the plurality of inputs to an appropriate output based upon the wavelength. An example of an optical router, such as router 420, is an arrayed wavelength grating router (AWGR). An AWGR functions similarly to the AWG 235 as described above. However, an AWGR is configured to receive a plurality of input signals as opposed to a single input signal as used with an AWG.

The router 420 may be operably connected to a control plane processor 425. The control plane processor 425 may receive an input control signal 427 from the router 420, process the input control signal and pass an output control signal 429 back to the router 420.

The control plane processor 425 may be further configured to determine and/or store any functional limitations of various devices operably connected to the outputs 430, 435, 440, . . . , 4YY, such as whether a device is capable of receiving multiple bursts simultaneously on different wavelengths. Based upon the functional limitations of an individual device, the control plane processor 425 may provide control signals to the router 420 to direct multiple inputs to a single output at a given instance of time. The control plane processor may further indicate to the router 420 the maximum number of input signals to direct to a single output at a given instance of time as well.

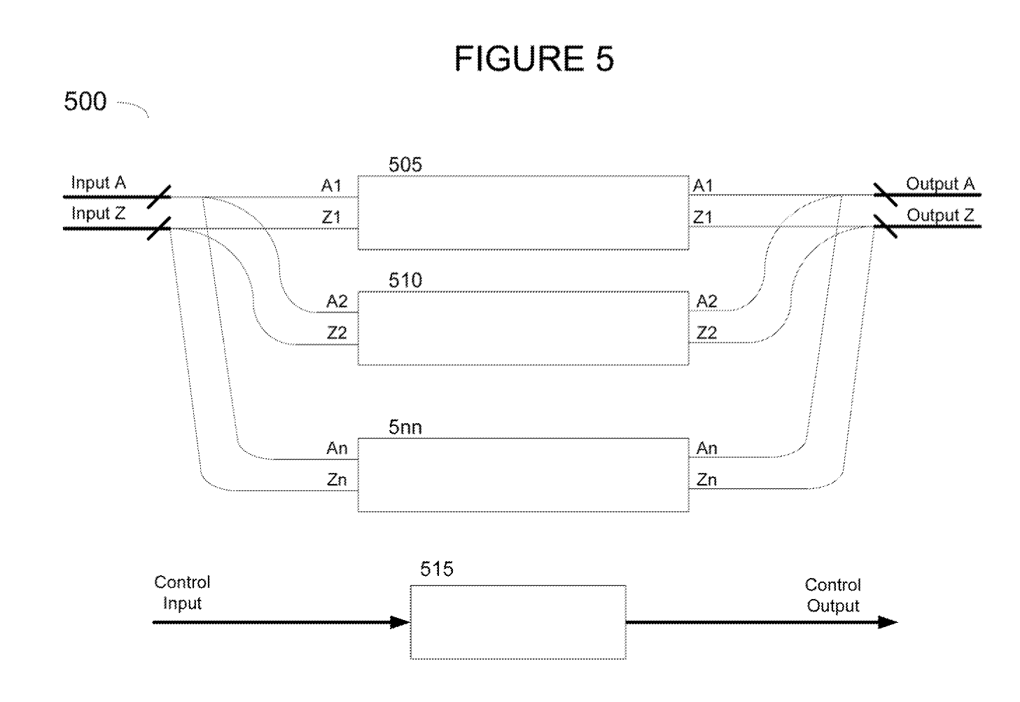

Multiple instances of the switches as described in FIGS. 2-4 may be used simultaneously to direct incoming signals to one or more outputs. For example, FIG. 5 illustrates an exemplary network 500 including multiple switch instantiations. Multiple switches 505, 510, . . . , 5nn may be arranged in parallel such that one fiber (i.e., A1, A2, . . . , An, Z1, Z2, . . . , Zn) may be operably connected to one of the switches. Thus, multiple bundled fibers such as input A and input Z may be directed from a single source switching device (not shown) to one of the multiple switches 505, 510, . . . , 5nn. The individual fibers are directed to an independent switch, each switch directing data received via the individual fibers to a corresponding output fiber. The multiple switches 505, 510, . . . , 5nn may share a common control plane including control plane processor 515. The control plane processor 515 may regulate routing and timing of incoming bursts to their destination as discussed above.

The output fibers may be again bundled into output A or output Z and directed to a destination switching device (not shown). Thus, the overall capacity of network 500 scales accordingly with the number of parallel fibers provided per source and destination switching device. The overall size of network 500, and the total number of parallel fibers used, is thus only limited by the current functional limits of the individual components used.

It should be noted that the control plane as discussed above in reference to FIGS. 2-5 may operate on separate wavelengths from the data plane while sharing common optic fibers. Alternatively, the control plane may operate with separate optic fibers from the data plane or operate on a completely separate communication medium such as copper wire. If on fiber, the control plane signals may be in parallel with data plane signals or in-band with data plane signals on different time allocations.

It should also be noted that the switches as shown in FIGS. 2-4 may be modified accordingly based upon the requirements of a network the switches are integrated into. For example, the amplifier 230 as shown in FIG. 2 may be removed, and individual inputs may be amplified prior to combining. Similarly, individual outputs may be amplified after demultiplexing. In such embodiments where amplification is used, the switch may further require an internal or external power source in order to provide power for the amplifier(s).

It should also be noted that while the disclosed embodiments refer to switch data operating over Ethernet, the switches may also be used with alternate and/or additional networking protocols. For example, a switch, such as switches 130, 300 and 400, may be integrated into an InfiniB and network or other similar computer cluster protocols, a Fiber Channel or other storage protocol (e.g., iSCSI) network, an Asynchronous Transfer Mode network, or another similar switched fabric network protocol configured to transfer data between nodes. It should also be noted that while the disclosed embodiments do not refer to switch data operating with any particular modulation technique, the switches may be used with alternate and/or additional modulation schemes. For example, a switch, such as switch 130, may be integrated into a network using OOK, QPSK, QAM, or other similar modulation techniques to transfer data between nodes.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A switch for switching optical signals, the switch comprising:
a plurality of inputs, wherein each of the plurality of inputs receives one of a plurality of input signals;
at least one coupling element operably connected to two or more of the plurality of inputs and configured to combine at least two of the input signals into a combined output signal;
a splitting element operably connected to the at least one coupling element and configured to demultiplex the combined output signal to produce a plurality of demultiplexed output signals; and
a control plane processor operably connected to at least one of the plurality of inputs and configured to determine a schedule for one or more devices operably connected to the plurality of inputs to transmit data bursts.

2. The switch of claim 1, further comprising a plurality of outputs each operably connected to the splitting element and configured to receive at least one of the demultiplexed output signals.

3. The switch of claim 2, wherein each of the plurality of outputs has a unique associated wavelength.

4. The switch of claim 2, wherein the control plane processor is further configured to schedule transmission of the data bursts such that a destination output receives a single transmitted data burst at a particular instance of time.

5. The switch of claim 1, wherein the splitting element comprises an arrayed wavelength guide (AWG).

6. The switch of claim 5, wherein the AWG is tuned to direct each of the plurality of demultiplexed output signals signal to a specific output based upon the wavelength of each of the plurality of demultiplexed output signals.

7. A switch for switching optical signals, the switch comprising:
a plurality of ports, each port comprising:
an input, and
an output;
at least one coupling element operably connected to a plurality of the inputs and configured to combine a plurality of input signals into a combined output signal;
a splitting element operably connected to the at least one coupling element and configured to demultiplex the combined output signal to produce a plurality of demultiplexed output signals and direct one of the demultiplexed output signals to at least one output; and
a control plane processor operably connected to at least one control input and configured to determine a schedule for one or more devices operably connected to the plurality of inputs to transmit data bursts intended for one or more devices operably connected to the plurality of outputs.

8. The switch of claim 1, wherein the control plane processor is further configured to schedule transmission of the data bursts such that a destination output receives a single transmitted data burst at a particular instance of time.

9. The switch of claim 7, wherein the splitting element comprises an arrayed wavelength guide (AWG).

10. The switch of claim 9, wherein the AWG is tuned to direct each of the demultiplexed output signals to a specific output based upon the wavelength of each demultiplexed output signal.

11. The switch of claim 7, wherein each output has a unique associated wavelength.

12. The switch of claim 7, wherein the coupling element comprises an optical combiner.

13. A switch for switching optical signals, the switch comprising:
a plurality of inputs, wherein each of the plurality of inputs receives one of a plurality of input signals, each of the plurality of input signals having a wavelength;
at least one router operably connected to the plurality of inputs and configured to route each of the input signals to one of a plurality of outputs based upon the wavelength of the input signal; and
a control plane processor operably connected to the at least one router and configured to determine a schedule for one or more devices operably connected to the plurality of inputs to transmit data bursts intended for one or more devices operably connected to the plurality of outputs.

14. The switch of claim 13, wherein the at least one router is an arrayed waveguide grating router (AWGR).

15. The switch of claim 13, wherein each of the plurality of outputs has a unique associated wavelength.

16. The switch of claim 13, wherein the control plane processor is further configured to schedule transmission of the data bursts such that a destination output receives a single transmitted data burst at a particular instance of time.

17. The switch of claim 16, the control plane processor is further configured to determine a number of inputs to connect to a destination output at a given time based upon one or more functional limitations of the device operably connected to a destination output.
